(19) United States
(12) Patent Application Publication
(10) Pub. No.: US 2009/0230661 A1
(43) Pub. Date: Sep. 17, 2009

(54) COLUMN-ATTACHED KNEE AIR BAG APPARATUS

(75) Inventors: Osamu Fukawatase, Aichi-ken (JP); Akiyoshi Sanada, Aichi-ken (JP); Yuichi Adachi, Aichi-ken (JP); Kazuaki Bito, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/382,191

(22) Filed: Mar. 10, 2009

(30) Foreign Application Priority Data
Mar. 12, 2008 (JP) 2008-062661

(51) Int. Cl. B60R 21/20

(52) U.S. Cl. 280/730.1

(57) ABSTRACT

A column-attached knee air bag apparatus is provided by being folded at inside of a column cover covering a steering column and is developed between an instrument panel and the knees of an occupant by being supplied with a gas. Upper and lower sides of the knee air bag are restricted such that a developing thickness in a front and rear direction is smaller at a lower portion than at an upper portion by an upper side strap and a lower side strap. An inflator and a diffuser are arranged such that an opening end of the diffuser of supplying a gas from the inflator to the knee air bag is disposed on a rear side of the instrument panel and at inside of a central expansion portion of the knee air bag.

### BACKGROUND OF THE INVENTION

1. Field of the Invention

The present invention relates to a column-attached knee air bag apparatus.

2. Related Art

There is known an occupant protecting apparatus in which a steering column cover is mounted with a knee air bag module (refer to, for example, JP-A-9-104317 and JP-A-2002-37003).

However, according to the above-described background art column-attached knee air bag apparatus, there is constituted a structure in which a knee air bag is developed from an upper side to a lower side in a vehicle up and down direction, and therefore, for example, there is a room for improvement in that the knee air bag is developed to a front side of the knee of a small stature occupant seated by making the knee proximate to a lower portion of an instrument panel in a short period of time.

### SUMMARY OF THE INVENTION

It is an object of the invention to provide a column-attached knee air bag apparatus capable of properly developing an upper portion and a lower portion of a knee air bag respectively in a short period of time by taking the above-described fact into consideration.

A column-attached knee air bag apparatus according to first aspect of the invention includes a knee air bag for protecting the knee of an occupant provided by being folded at inside of a column cover covering a steering column and developed between an instrument panel and the knee of the occupant by being supplied with a gas, an upper side strap provided at inside of the knee air bag and restricting a thickness in a vehicle front and rear direction at an upper portion in a vehicle up and down direction of the knee air bag to a predetermined thickness when the knee air bag is developed, a lower side strap provided at inside of the air bag and restricting a thickness in the vehicle front and rear direction of a lower portion in the vehicle up and down direction of the knee air bag to a thickness smaller than the thickness of the upper portion when the knee air bag is developed, and a gas supplying device having a gas supply port to the knee air bag, wherein the gas supply port is arranged to be disposed on a rear side in the vehicle front and rear direction relative to the instrument panel at inside of the column cover and at inside of a central expansion chamber between the upper side strap and the lower side strap at inside of the knee air bag.

According to the column-attached knee air bag apparatus of the first aspect of the invention, when the gas supplying device is operated in a case of detecting or predicting, for example, a front face collision of a vehicle, the gas supplying device generates the gas, and the gas is supplied to the knee air bag by way of the gas supply port. Thereby, the knee air bag is developed between the instrument panel both on left and right sides of the column cover and the knee of the occupant and the knee of the occupant is protected.

Here, the gas supplying device supplies the gas to the central expansion chamber of the knee air bag on a rear side of the instrument panel, and therefore, expansion of the knee air bag to the rear side of the instrument panel is promoted, and the central expansion chamber is expanded and developed precedingly by including an upper portion and a lower portion (portions thereof) of the air bag. Thereby, the knee air bag is developed in a short period time as a whole. Further, the thickness in the front and rear direction of the lower portion of the knee air bag in which the developing thickness in the front and rear direction is restricted by the lower side strap is smaller than that of the upper portion in which the developing thickness in the front and rear direction is restricted by the upper side strap, and therefore, even when a gap between the knee of the occupant and the instrument panel is small, the lower portion is developed to be brought into the gap (front side of the knee of the occupant).

In this way, according to the column-attached knee air bag apparatus of the first aspect of the invention, the upper portion and the lower portion of the knee air bag can be developed properly respectively in the short period of time.

According to the column-attached knee air bag apparatus according to second aspect of the invention, the gas supplying device is arranged such that the gas supply port is disposed to be more proximate to the upper side strap than the lower side strap at inside of the central expansion chamber in a state of developing the knee air bag.

According to the column-attached knee air bag apparatus of the second aspect of the invention, the gas supply port of the gas supplying device is disposed is disposed to be proximate to the upper side strap, and therefore, the upper portion having a volume relatively larger than that of the lower portion of the knee air bag is precedingly expanded and developed in a short period of time. On the other hand, the lower portion having a volume (thickness) smaller than that of the upper portion is developed in a short period of time. Thereby, a necessary performance of constricting the knee can be achieved for occupants of various statures.

A column-attached knee air bag apparatus according to third aspect of the invention includes a knee air bag for protecting a knee of an occupant provided to be folded at inside of a column cover covering a steering column and developed between an instrument panel and the knee of the occupant by being supplied with a gas, an upper side strap provided at inside of the knee air bag and restricting a thickness in a vehicle front and rear direction of an upper portion in a vehicle up and down direction of the knee air bag to a predetermined thickness when the knee air bag is developed, a lower side strap provided at inside of the knee air bag and restricting a thickness in the vehicle front and rear direction of a lower portion in the vehicle up and down direction of the knee air bag to a thickness smaller than the thickness of the upper portion when the air bag is developed, and a gas supplying device having a gas supply port to the knee air bag, wherein the gas supply port is arranged such that the gas supply port is disposed to be more proximate to the upper side strap than the lower side strap at inside of a central expansion chamber between the upper side strap and the lower side strap at inside of the knee air bag in a developed state.

According to the column-attached knee air bag apparatus of the third aspect of the invention, for example, when the gas supplying device is operated in a case of detecting or predicting front face collision of a vehicle, the gas supplying device generates the gas, and the gas is supplied to the knee air bag by way of the gas supply port. Thereby, the knee air bag is developed between the instrument panel and the knee of the occupant on both left and right sides relative to the column cover, and the knee of the occupant is protected.

Here, according to the gas supplying device, in order to supply the gas to the central expansion chamber of the knee air bag, in the knee air bag, the central expansion chamber including the upper portion and the lower portion is expanded and developed precedingly in the short period of time. Further, the gas supply port of the gas supplying device is disposed to be proximate to the upper side strap, and therefore, the upper portion having a volume relatively larger than that of the lower portion of the knee air bag can be expanded and developed in the short period of time precedingly to the lower portion. On the other hand, the lower portion having a volume (thickness) smaller than that of the upper portion of the knee air bag is developed in the short period of time. Further, the lower portion of the knee air bag in which the developing thickness in the front and rear direction is restricted as described above is developed to be brought into a gap (front side of the knee of the occupant) even when the gap between the knee of the occupant and the instrument panel is small. Thereby, a necessary performance of constructing the knee can be achieved for occupants of various statures.

In this way, according to the column-attached knee air bag apparatus of the third aspect of the invention, the upper portion and the lower portion of the knee air bag can be developed properly in the short period of time.

According to the column-attached knee air bag apparatus according to fourth aspect of the invention, the knee air bag is contained at inside of an air bag case in a state of cactus-folding at least a portion of an upper expansion portion developed to an upper side in the vehicle up and down direction of the upper side strap downwardly in the vehicle up and down direction, roll-folding portions on both left and right sides relative to the gas supply port of the gas supplying device inwardly in a left and right direction so as not to overlap the gas supplying device, and roll-folding a portion including a lower expansion portion developed on the lower side in the vehicle up and down direction of the lower side strap upwardly in the vehicle up and down direction.

According to the column-attached knee air bag apparatus of the fourth aspect of the invention, the portion of the upper expansion portion of the knee air bag is cactus-folded to form a recess opened upwardly in the vehicle up and down direction relative to the portion including the central expansion portion, and therefore, the upper portion of the knee air bag is developed in the short period of time in comparison with the case of other way of folding. Thereby, when the central expansion chamber is developed, the upper expansion chamber is expanded and developed in the shorter period of time precedingly to the roll-folded lower expansion chamber and the above-described effect becomes further significant.

As explained above, the column-attached knee air bag apparatus according to the invention achieves an excellent effect of capable of properly developing the upper portion and the lower portion of the knee air bag respectively in the short period of time.

### BRIEF DESCRIPTION OF THE DRAWINGS

FIG. 1 is a partially notched side view showing a column-attached knee air bag apparatus according to an embodiment of the invention.

FIG. 2 is a partially notched rear view of a state of developing a knee air bag of the column-attached knee air bag apparatus according to the embodiment of the invention.

FIG. 3 is a perspective view of a state of developing the knee air bag of the column-attached knee air bag apparatus according to the embodiment of the invention.

FIG. 4 illustrates views showing an inflator and a diffuser of the column-attached knee air bag apparatus according to the embodiment of the invention, (A) is a perspective view, (B) is a side view.

FIG. 5 illustrates views showing a state before folding the knee air bag constituting the column-attached knee air bag apparatus according to the embodiment of the invention, (A) is a rear view, (B) is a side sectional view.

FIG. 6 illustrates views showing a state of cactus-folding an upper portion of the knee air bag constituting the column-attached knee air bag apparatus according to the embodiment of the invention, (A) is a rear view, (B) is a side sectional view.

FIG. 7 illustrates views showing a first procedure of roll-folding both left and right side portions of the knee air bag constituting the column-attached knee air bag apparatus according to the embodiment of the invention, (A) is a rear view, (B) is a bottom view.

FIG. 8 illustrates views showing a second procedure of roll-folding both left and right side portions of the knee air bag constituting the column-attached knee air bag apparatus according to the embodiment of the invention, (A) is a rear view, (B) is a bottom view.

FIG. 9 illustrates views showing a third procedure of roll-folding both left and right side portions of the knee air bag constituting the column-attached knee air bag apparatus according to the embodiment of the invention, (A) is a rear view, (B) is a bottom view.

FIG. 10 illustrates views showing a first procedure of roll-folding a lower portion of the knee air bag constituting the column-attached knee air bag apparatus according to the embodiment of the invention, (A) is a rear view, (B) is a side view.

FIG. 11 illustrates views showing a second procedure of roll-folding a lower portion of the knee air bag constituting the column-attached knee air bag apparatus according to the embodiment of the invention, (A) is a rear view, (B) is a side view.

### DETAILED DESCRIPTION OF THE PREFERRED EMBODIMENTS

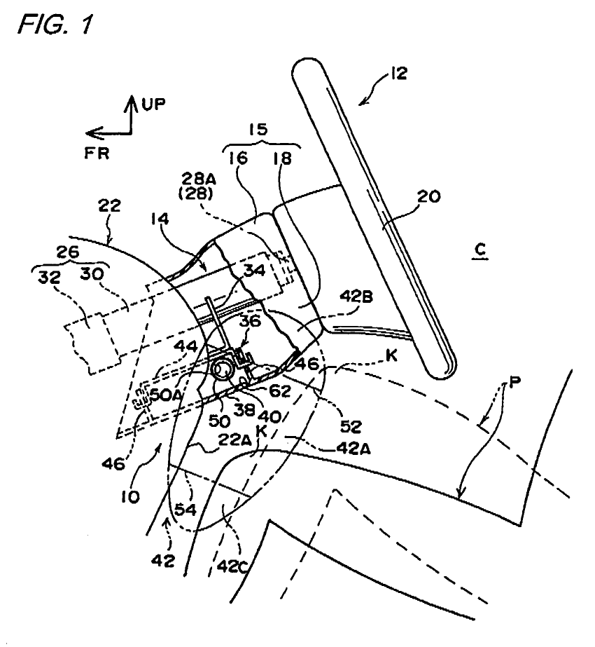

An explanation will be given of a column-attached knee air bag apparatus 10 according to an embodiment of the invention in reference to FIG. 1 through FIG. 5. Further, an arrow mark FR, an arrow mark UP, an arrow mark W pertinently described in the respective drawings respectively indicate a front direction (advancing direction), an upper direction, a vehicle width direction of an automobile to which the column-attached knee air bag apparatus 10 is applied. First, an outline constitution of a steering column apparatus 12 to which the column-attached knee air bag apparatus 10 is applied will be explained, successively, the column-attached knee air bag apparatus 10 will be explained.

### (Constitution of Steering Column Apparatus)

FIG. 1 shows an outline total constitution of the steering column apparatus 10 by a partially notched side view. As shown by the drawing, the steering column apparatus 12 is constituted by constituting main portions by a steering column main body 14, a column cover 15 covering a rear end side in a vehicle front and rear direction of the steering column main body 14, and a steering wheel 20 arranged at a rear end portion in the vehicle front and rear direction of the steering column main body 14.

According to the steering column apparatus 12, the steering column main body 14 is inserted to an opening portion formed at an instrument panel 22 to be directed to a side of a driver's seat in a forwardly inclined attitude. The steering column apparatus 12 is supported by an instrument panel reinforcement (not illustrated) hung between left and right front pillars at inside of the instrument panel 22 by way of, for example, a support structure, not illustrated.

In a state of integrating the steering column apparatus 12 to a vehicle body, a portion of a front end side of the column cover 15 is arranged at inside of the instrument panel 22, and a remaining portion thereof is arranged in a state of being projected to inside of a cabin C. The column cover 15 is constituted by a structure divided in two in an up and down direction. Specifically, the column cover 15 is formed in a shape of a cylinder as a whole by a column upper cover 16 constituting an upper portion thereof in the vehicle up and down direction, and a column lower cover 18.

The steering column main body 14 includes a column tube 26 substantially constituting a shape of a circular cylinder, and a steering main shaft 28 is rotatably supported by an axis core portion of the column tube 26. The steering main shaft 28 is divided in two in a column axis direction, and a shaft 28A on an upper side and a shaft on a lower side (not illustrated) are connected by spline fitting. Therefore, the shaft 28A on the upper side is made to be able to displace relative to the shaft on the lower side in an axial direction within a range of a predetermined stroke, and a relative rotation thereof is made to be unable to carry out. Further, the steering wheel 20 exerted with a steering force from a driver is fastened to be fixed to a rear end portion of the shaft 28a on the upper side by a nut.

Further, the column tube 26 covering the steering main shaft 28 is divided in two in a column shaft direction (double tube structure), and an inner tube 30 arranged on a side of an occupant (steering wheel 20) and an outer tube 32 arranged on a counter occupant side (steering gear box side) are connected by spline fitting. In the column tube 26, an inner diameter of the outer tube 32 is set to be larger than an outer diameter of the inner tube 30, for example, in secondary collision of the occupant to the steering wheel 20, by sliding the inner tube 30 to inside of the outer tube 32 to contract, an energy in the secondary collision is made to be absorbed.

(Constitution of Column-Attached Knee Air Bag Apparatus)

A rear end side in the vehicle front and rear direction of the steering column main body 14 of the above-described steering column apparatus 12 and a lower side in a vehicle up and down direction are arranged with the column-attached knee air bag apparatus 10 operated when a front face collision of the vehicle is detected or predicted. The column-attached knee air bag apparatus 10 is constituted by constituting main portions by an air bag module 36 fixedly arranged to a lower side of the inner tube 30 by way of a bracket 34, and an air bag door 38 formed at the column lower cover 18 constituting a lower portion of the column cover 15.

The air bag module 36 includes an inflator 40 of generating a gas by being operated, a knee air bag 42 expanded to be developed by a gas supplied from the inflator 40, and a module case 44 constituting an air bag case containing these. The inflator 40 is arranged substantially orthogonal to the steering column main body 14 to constitute a longitudinal direction by the vehicle width direction, and is fixed to the bracket case 34 along with the module case 44 by fastening means comprising, for example, a stud bolt and a nut by way of a diffuser 50 mentioned later. Thereby, the air bag module 36 is fixed to the inner tube 30 of the steering column main body 14 as described above.

Under the state, both end portions in the vehicle front and rear direction of the module case 44 are respectively locked by front and rear ribs 46 provided at the column lower cover 18, and contains the inflator 40, and the knee air bag 42 on a lower side of the inner tube 30. The module case 44 may be constituted by, for example, a cloth member or the like having both flexibility and a softness, or may be constituted to be comparatively high rigid by a metal or the like.

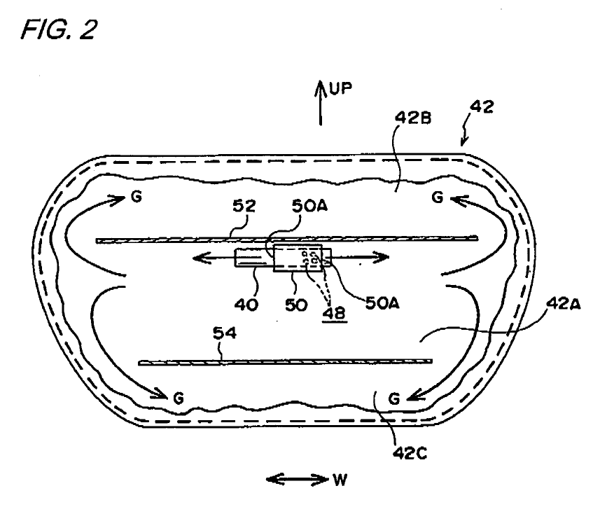

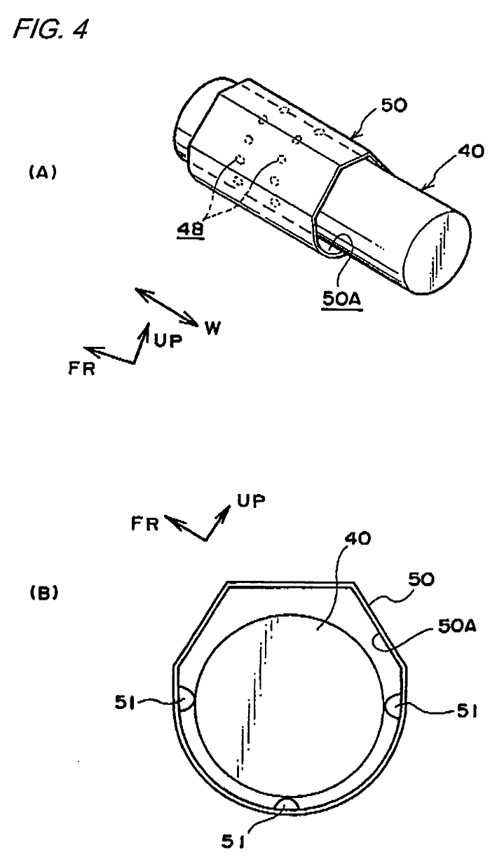

Further, as shown in FIG. 2 and FIG. 4, the column-attached knee air bag apparatus 10 includes the diffuser 50 constituting a rectifying means covering a portion formed in a shape of a cylinder and including a portion of forming a gas injecting hole 48 at the inflator 40 from an outer peripheral side. The diffuser 50 is fixed to the inflator 40 by bringing a calking portion 51 formed by calking a plurality of portions thereof in a peripheral direction into contact with an outer periphery of the inflator 40.

The diffuser 50 constitutes opening ends 50A respectively constituting gas supply ports by both ends in the vehicle width direction. Thereby, according to the column-attached knee air bag apparatus 10, there is constructed a constitution in which the gas injected from the gas injecting hole 48 of the inflator 40 is rectified to a flow along the vehicle width direction and is injected respectively from the left and right opening ends 50A.

Therefore, according to the embodiment, the inflator 40 and the diffuser 50 correspond to a gas supplying device according to the invention. Further, according to the column-attached knee air bag apparatus 10, as shown in FIG. 1, the inflator 40 and the diffuser 50 are arranged such that the opening end 50A of the diffuser 50 is disposed on a rear side in the vehicle front and rear direction relative to a design face 22A of the instrument panel 22.

The knee air bag 42 contains a portion including the left and right opening ends 50A constituting the gas supply ports of the inflator 40 and the diffuser 50, that is, the gas supplying device, and is made to be expanded to develop by being supplied with the gas of the inflator 40 from the left and right opening ends 50A. The knee air bag 42 is arranged at inside of the module case 44 between the column lower cover 18 and the bracket 34 in a folded state as described later before operating the column-attached knee air bag apparatus 10.

As shown by an imaginary line in FIG. 1, the knee air bag 42 is supplied with the gas from the inflator 40, developed between the design face 22A of the instrument panel 22 and the both knees K of the occupant P and protects the both knees K. That is, the knee air bag 42 receives the both knees K (restrains forward movement thereof) while being supported by the design face 22A of the instrument panel 22 as a reaction force face. Further, the knee K indicated by a broken line in FIG. 1 designates the both knees K of the occupant having a standard or a large stature and the knee K indicated by a bold line indicates the knee K of the occupant of a small stature.

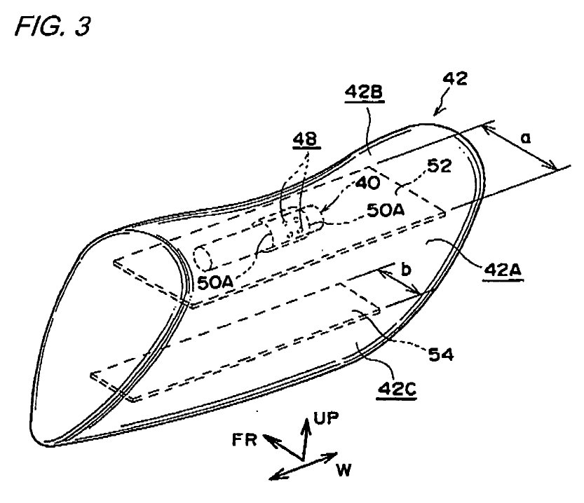

When supplemented to a state of developing the knee air bag 42, the knee air bag 42 is developed as shown in FIG. 2 and FIG. 3. Specifically, an inner portion of the knee air bag 42 is provided with upper and lower pairs of upper side strap 52 and lower side strap 54 to be developed to be separated from each other in the vehicle up and down direction. The upper side strap 52 and the lower side strap 54 are respectively constituted by cloth members substantially constituting a shape of a long rectangle in the vehicle width direction in a plane view thereof. A width a along the vehicle front and rear direction of the upper side strap 52 is made to be larger than a width b along the vehicle front and rear direction of the lower side strap 54 (a>b).

Thereby, as shown in FIG. 1 and FIG. 3, the knee air bag 42 is constructed by a constitution in which a thickness thereof in the vehicle front and rear direction in a developed state is larger at an upper portion thereof in the vehicle up and down direction than at a lower portion thereof. Further, a portion expanded and developed between the upper side strap 52 and the lower side strap 54 at inside of the knee air bag 42 is referred to as a center expansion chamber 42A, and a portion thereof expanded on an upper side of the upper side strap 52 is referred to as an upper expansion chamber 42B, and a portion thereof expanded on a lower side of the lower side strap 54 is referred to as a lower expansion chamber 42C.

Further, as shown in FIG. 2, according to the column-attached knee air bag apparatus 10, the inflator 40 is arranged substantially at a center portion in a bag width direction made to coincide with a vehicle width direction at inside of the central expansion portion 42A of the knee air bag 42 in the developed state. Further, according to the embodiment, the left and right opening ends 50A of the diffuser 50 from which the gas from the inflator 40 is injected are arranged to be disposed to be more proximate to the upper side strap 52 than the lower side strap 54 in the central expansion portion 42A of the knee air bag 42 in the developed state.

Further, the upper expansion chamber 42B constituting the upper side portion of the central expansion portion 42A of the knee air bag 42 and the lower expansion portion 42C constituting the lower side portion of the upper side expansion chamber 44B are expanded to develop by being supplied with a gas by going around end portions in the longitudinal direction of the upper side strap 52 and the lower side strap 54 as indicated by an arrow mark G in FIG. 2. Further, the knee air bag according to the embodiment is constructed by a constitution in which a length along the vehicle width direction is longer on the side of the upper expansion portion 42B than the side of the lower expansion portion 42C in a rear view thereof.

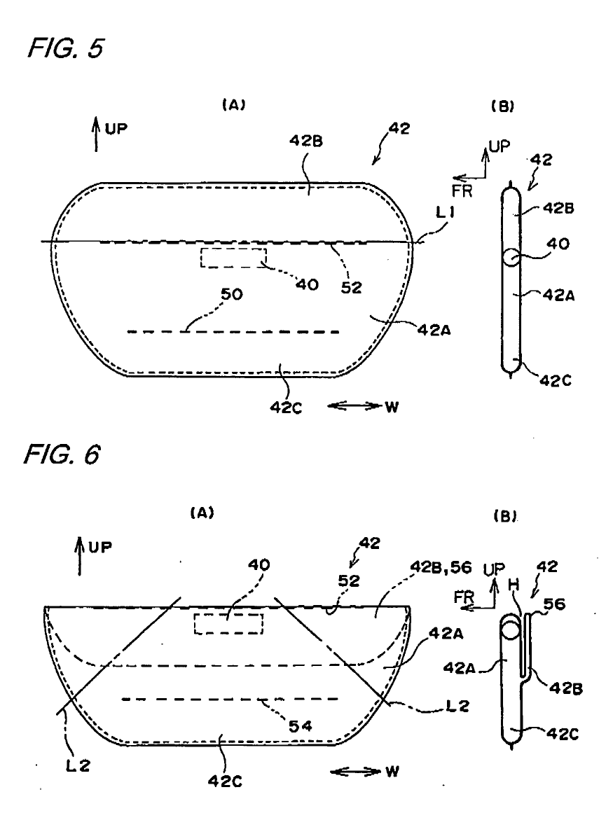

As shown in FIG. 5, the knee air bag 52 explained above is folded and is contained at inside of the module case 44. Specifically, as shown at (A) and (B) in FIG. 5, a portion thereof including the upper expansion chamber 42B of the knee air bag 42 before being folded is cactus-folded as shown at (A) and (B) in FIG. 6 such that an imaginary line L1 along a vicinity of a boundary of the central expansion portion 42A and the upper expansion chamber 42B (a vicinity of an upper edge of the inflator 40) constitutes an uppermost portion. That is, a portion constituting the upper expansion chamber 42B at the knee air bag 42 is folded to an inner side of the side of the central expansion portion 42A to form a recess H opened to an upper side (refer to (B) in FIG. 6) to form a cactus-folded portion 56.

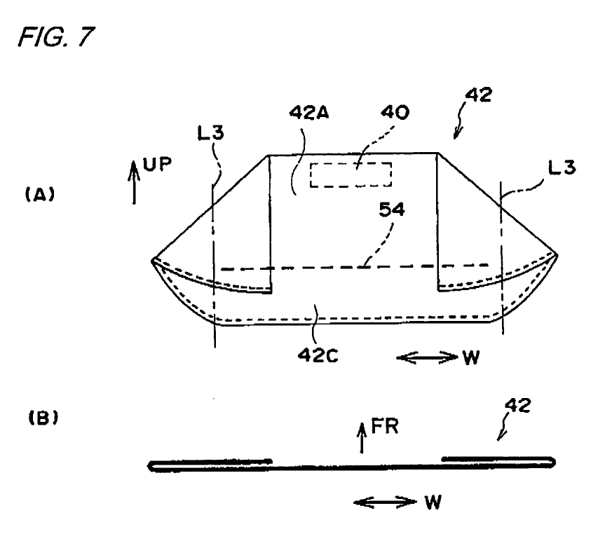

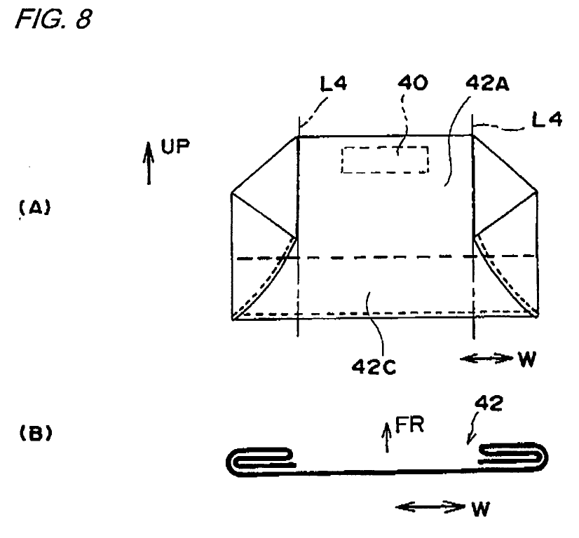

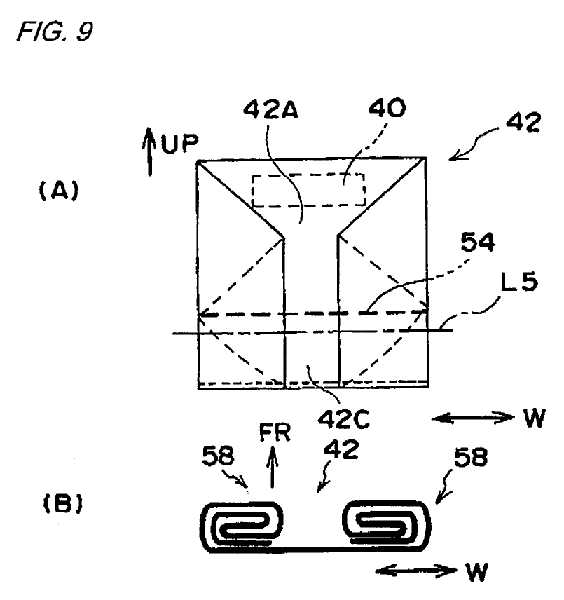

Further, according to the knee air bag 42, both side portions in a width direction (left and right direction) relative to the inflator 40 are roll-folded inwardly in the width direction. Specifically, both left and right ends thereof are folded back inwardly as shown at (A) and (B) in FIG. 7 along imaginary lines L2 (folding pleats) of FIG. 6-(A). Further, both left and right ends thereof are folded back inwardly as shown at (A) and (B) in FIG. 8 along imaginary lines L3 (folding pleats) of FIG. 7-(A), and both left and right ends thereof are folded back inwardly as shown at (A) and (B) in FIG. 9 along imaginary lines L4 (folding pleats) of FIG. 8-(A). Thereby, left and right roll folding portions 58 as shown at (A) and (B) in FIG. 9 are formed not to overlap the inflator 40 (diffuser 50) as shown at (A) in FIG. 9. As shown at (B) in FIG. 9, the left and right roll-folding portions 58 are formed on a front side in the vehicle front and rear direction. Further, only folding back at the imaginary lines L3, L4 along the up and down direction may be regarded as the roll-folding.

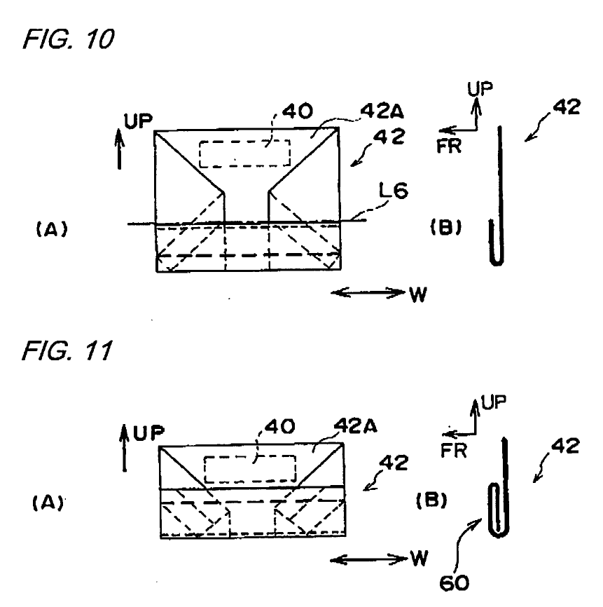

Successively, according to the knee air bag 42, a lower side portion relative to the inflator 40 is roll-folded upwardly. Specifically, a lower end is folded back upwardly as shown at (A) and (B) in FIG. 10 along the imaginary line L5 (folding pleat) of FIG. 9-(A), and both left and right ends thereof are folded back upwardly in the width direction as shown at (A) and (B) in FIG. 11 along an imaginary line L6 (folding pleat) of FIG. 10-(A). Thereby, a lower roll-folded portion 60 as shown at (B) in FIG. 11 is formed not to overlap the inflator 40 (diffuser 50) as shown at (A) in FIG. 11. As shown at (B) in FIG. 11, the lower roll-folded portion 60 is formed on the front side in the vehicle front and rear direction.

The knee air bag 42 is contained at inside of the module case 44 in a folded state as shown in FIG. 11. Further, an order of folding the knee air bag 42 is an order of explaining the folded portion as described above, and is folded in an order of imaginary lines L1 through L6.

On the other hand, as shown in FIG. 1, the air bag door 38 is broken to be developed when a bag expansion pressure becomes equal to or larger than a predetermined value by setting a predetermined tear line 62 on an inner side of the column lower cover 18. According to the embodiment, the tear line 62 is formed as a thin-walled portion recessed in a groove-like shape. The tear line 62 is formed by dividing the air bag 38 into a plurality of portions (to be folded back at a plurality of fold-back portions along an opening edge of passing the knee air bag 42) to permit the knee air bag 42 to develop to outside of the column cover 15 although illustration thereof is omitted.

According to the column-attached knee air bag apparatus 10 explained above, a timing of operating the inflator 40 is controlled by an air bag ECU constituting controlling means, not illustrated. The air bag ECU is made to operate the inflator 40 when it is determined that front face collision of the vehicle applied with the column-attached knee air bag apparatus 10 is detected or predicted based on a signal from, for example, a front collision sensor.

Next, an operation of the embodiment will be explained.

According to the column-attached knee air bag apparatus 10 having the above-described constitution, the air bag ECU which determines that the front face collision of the vehicle applied therewith is detected or predicted based on the signal from the front collision sensor operates the inflator 40. Then, a large amount of a gas is generated at the inflator 40, the gas is injected from the gas injection holes 48 of the inflator 40 to the both sides in the vehicle width direction from the left and right opening ends 50A by way of inside of the diffuser 50 (an interval between the inflator 40 and diffuser 50) and is supplied to inside of the knee air bag. Thereby, the knee air bag 40 is expanded to be developed, and when a pressure of developing the knee air bag 42 operated to the air bag door 38 reaches the predetermined value, the column lower cover 18 is broken along the tear line 62, and the air bag door 38 is developed.

Then, the knee air bag 42 is expanded to be developed on the lower side in the vehicle up and down direction relative to the steering column apparatus 12 and to the both sides in the vehicle width direction (substantially along the design face 22A of the instrument panel 22). Thereby, as shown by the imaginary line in FIG. 1, the knee air bag 42 expanded to be developed is interposed between the design face 22A (reaction force face) of the instrument panel 22 and the both knees K of the occupant P, and the both knees K are received by the knee air bag 42 to be protected thereby.

When supplemented with regard to the development of the knee air bag 42 folded as described above, the gas generated by the inflator 40 is injected from the respective opening ends 50A of the diffuser 50 to the left and right sides (vehicle width direction), further, supply of the gas to a lower portion (lower portion in the developed state) of the knee air bag 42 is restricted by the lower side strap 54, and therefore, the knee air bag 42 is developed such that roll-folds of mainly the left and right roll-fold portion 58 are resolved. That is, expansion and development to the both sides in the vehicle width direction of the central expansion portion 42A are precedingly carried out. In accordance with the development in the left and right direction (vehicle width direction), when there is brought about a state of permitting the gas supplied in side directions of the upper side strap 52 and the lower side strap 54, cactus-folding of the cactus holding portion 56 is released, the upper expansion chamber 42B is expanded and developed, and roll-fold of the lower-fold portion 60 is released and the lower expansion portion 42C is expanded and developed.

Here, according to the column-attached knee air bag apparatus 10, the inflator 40 and the diffuser 50 are arranged to supply the gas to the central expansion portion 42A of the knee air bag 42 on the rear side of the instrument panel 22 (side of the cabin C relative to the design face 22A), and therefore, according to the knee air bag 42, the central expansion portion 42A including the upper portion and the lower portion (constituting respective portions of the upper portion and the lower portion) is expanded and developed in a short period of time. That is, the central expansion portion 42A is expanded and developed in the short period of time on the both left and right sides relative to the instrument panel 22 since a volume thereof is smaller than that of the total of the knee air bag 43 without being partially expanded at inside of the instrument panel 22.

Further, according to the column-attached knee air bag apparatus 10, the opening ends 54A of the diffuser 50 at which the gas of the inflator 40 is supplied to the knee air bag 42 are arranged to be more proximate to the upper side strap 52 than the lower side strap 54, and therefore, the upper expansion chamber 42B is developed more precedingly than the lower expansion portion 44C. Particularly, the upper expansion chamber 44B is folded by cactus folding which is easy to be developed in comparison with roll folding, and therefore, the upper expansion chamber 42B is developed in a shorter period of time. Thereby, according to the column-attached knee air bag apparatus 10, the knee air bag 42 is developed in the short period of time on the front side of the knees of an occupant having a standard stature or the occupant having a large-sized structure.

On the other hand, according to the lower portion of the knee air bag 42, the thickness in the vehicle front and rear direction is restrained less than that of the upper portion at which the thickness in the vehicle front and rear direction is restricted by the upper side strap 52, and therefore, the lower portion is expanded and developed in the short period of time in comparison with a constitution in which the lower portion is developed to a thickness equivalent to that of the upper portion.

Further, according to the column-attached knee air bag apparatus 10, as described above, the thickness in the vehicle front and rear direction of the lower portion of the knee air bag 42 is small, and therefore, the lower portion of the knee air bag 42 can be developed on the front side of the knees of an occupant having a small-sized stature (between the both knees K and the design face 22A of the instrument panel 22). That is, there is a case in which the small stature occupant is frequently seated by making the seat proximate to the frontmost, in such a case, driving is carried out by an attitude by which the knee K is proximate to the design face 22A of the instrument panel 22 (a gap between the design face 22A and the both knees K is small), and therefore, in a comparative example in which upper and lower developed thicknesses of the knee air bag developed from the upper side to the lower side in the vehicle upper and lower direction are equivalent, it is difficult to develop the knee air bag to the front side of the seat of only the small stature occupant. In contrast thereto, according to the column-attached knee air bag apparatus 10, the knee air bag 42 in which the developed thickness is smaller at the lower portion than that at the upper portion is provided, and therefore, as described above, both of shortening of developing time by small volume formation of the lower portion and development of the knee air bag 42 (lower portion thereof) to the front side of the knees of the small stature occupant by restricting the developing thickness of the lower portion are achieved.

In this way, according to the column-attached knee air bag apparatus 10 according to the embodiment, the upper portion and the lower portion of the knee air bag 42 can be developed in the short period of time. Thereby, a necessary function of constricting the knees can be achieved for occupants of various statures from small-sized stature to the large-sized stature.

Further, although according to the above-described embodiment, there is shown an example in which the left and right opening ends 50A of the diffuser 50 covering the inflator 40 constitute the gas supply ports according to the invention, the invention is not limited thereto but there may be constructed a constitution in which the inflator 40 includes a gas injection hole of directly injecting the gas to the central expansion portion 42A of the knee air bag 42. Further, the inflator 40 is not restricted to the constitution of being arranged substantially orthogonal to the steering column main body 14 but may be constituted to be arranged substantially in parallel with the steering column main body 14.

What is claimed is:

1. A column-attached knee air bag apparatus comprising:
a knee air bag for protecting a knee of an occupant provided by being folded at inside of a column cover covering a steering column and developed between an instrument panel and the knee of the occupant by being supplied with a gas;
an upper side strap provided at inside of the knee air bag and restricting a thickness in a vehicle front and rear direction at an upper portion in a vehicle up and down direction of the knee air bag to a predetermined thickness when the knee air bag is developed;
a lower side strap provided at inside of the air bag and restricting a thickness in the vehicle front and rear direction of a lower portion in the vehicle up and down direction of the knee air bag to a thickness smaller than the thickness of the upper portion when the knee air bag is developed; and
a gas supplying device having a gas supply port to the knee air bag,
wherein the gas supply port is arranged to be disposed on a rear side in the vehicle front and rear direction relative to the instrument panel at inside of the column cover and at inside of a central expansion chamber between the upper side strap and the lower side strap at inside of the knee air bag.

2. The column-attached knee air bag apparatus according to claim 1, wherein the gas supplying device is arranged such that the gas supply port is disposed to be more proximate to the upper side strap than the lower side strap at inside of the central expansion chamber in a state of developing the knee air bag.

3. The column-attached knee air bag apparatus according to claim 2, wherein the knee air bag is contained at inside of an air bag case in a state of cactus-folding at least a portion of an upper expansion portion developed to an upper side in the vehicle up and down direction of the upper side strap downwardly in the vehicle up and down direction, roll-folding portions on both left and right sides relative to the gas supply port of the gas supplying device inwardly in a left and right direction so as not to overlap the gas supplying device, and roll-folding a portion including a lower expansion portion developed to a lower side in the vehicle up and down direction of the lower side strap upwardly in the vehicle up and down direction.

4. A column-attached knee air bag apparatus comprising:
a knee air bag for protecting the knee of an occupant provided to be folded at inside of a column cover covering a steering column and developed between an instrument panel and the knee of the occupant by being supplied with a gas;
an upper side strap provided at inside of the knee air bag and restricting a thickness in a vehicle front and rear direction of an upper portion in a vehicle up and down direction of the knee air bag to a predetermined thickness when the knee air bag is developed;
a lower side strap provided at inside of the knee air bag and restricting a thickness in the vehicle front and rear direction of a lower portion in the vehicle up and down direction of the knee air bag to a thickness smaller than the thickness of the upper portion when the air bag is developed; and
a gas supplying device having a gas supply port to the knee air bag,
wherein the gas supply port is arranged such that the gas supply port is disposed to be more proximate to the upper side strap than the lower side strap at inside of a central expansion chamber between the upper side strap and the lower side strap at inside of the knee air bag in a developed state.

5. The column-attached knee air bag apparatus according to claim 4, wherein the knee air bag is contained at inside of an air bag case in a state of cactus-folding at least a portion of an upper expansion portion developed to an upper side in the vehicle up and down direction of the upper side strap downwardly in the vehicle up and down direction, roll-folding portions on both left and right sides relative to the gas supply port of the gas supplying device inwardly in a left and right direction so as not to overlap the gas supplying device, and roll-folding a portion including a lower expansion portion developed to a lower side in the vehicle up and down direction of the lower side strap upwardly in the vehicle up and down direction.
